(19) United States
(12) Patent Application Publication
(10) Pub. No.: US 2006/0230279 A1
(43) Pub. Date: Oct. 12, 2006

(54) Methods, systems, and computer program products for establishing trusted access to a communication network

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/093,564

(22) Filed: Mar. 30, 2005

(51) Int. Cl. H04L 9/00

(52) U.S. Cl. 713/182

(57) ABSTRACT

Methods, systems, and computer program products for establishing trusted access to a communication network by a client detect an available access network providing access to a target communication network and determine a trust indication associated with the available access network. The trust indication is originated by a trust authority that is separate from the client and from the available access network. A determination of whether to access the communication network via the available access network is made at the client based on the trust indication. The trust-related characteristics and the trust indication are determined by the trust authority, which makes the determined trust indication available to clients detecting the access network. For example, a trust indication message may be sent to a client prior to providing access by the client to the target communication network. The access is provided based on a response by the client to the received trust indication message.

### RELATED APPLICATIONS

This application is related to a commonly assigned U.S. patent application entitled “Methods, Systems, And Computer Program Products for Determining a Trust Indication Associated with Access to a Communication Network”, filed on even date herewith, the content of which is incorporated by reference herein in its entirety.

### TECHNICAL FIELD

The subject matter described herein relates to communications with a network. More particularly, the subject matter described herein relates to establishing trusted access to a communication network.

### BACKGROUND

Advancements in communication technologies have led to expansive growth in the availability and use of communication networks. For example, the Internet's ubiquitous nature and limitless supply of practical applications has fueled a rapid growth in providing access to the Internet to users wherever they may be across the world. Such access may be provided with or without the use of security, authentication, and encryption technologies, depending on the user's requirements. Common methods of access include dial-up, landline broadband (over coaxial cable, fiber optic cables or copper wires), wireless broadband, and satellite.

Many public places, such as airports, libraries, Internet cafes, and businesses provide access to the Internet to cater to users away from their home or business. Internet access points in some public places, like airport halls, are sometimes designed just for brief use while standing. Various terms such as “public Internet kiosk”, “public access terminal”, and “Web payphone” have been used to describe these access points.

Wi-Fi provides wireless access to communication networks, and therefore may provide Internet access. Wi-Fi “hotspots” providing such access include Wi-Fi cafes, where a potential user typically brings his or her own wireless-enabled device, such as a notebook computer or personal digital assistant (PDA). These services may be free to all, free to customers only, or fee-based. A hotspot need not be limited to a confined location. Whole campuses, parks, and even metropolitan areas have been Wi-Fi enabled.

With many people using Wi-Fi hotspots and other access points to access the Internet and other communication networks, new security threats arise from the access provider and other users of the access point. Access is typically provided via networks that are privately owned by individuals or small companies where the user doesn't know the owner. It's a simple matter for the owner to “sniff” traffic on his network on the way to the Internet to steal personal information from the users of the network.

In addition, many business and residential users do not bother to protect their network. As a result, if others in close proximity to the business or network can gain unauthorized access to the user's network. For example, users have been known to identify locations that provide unsecured access, such as active Wi-Fi access points, either by physically marking a building or sidewalk with chalk or by placing its street address on a Website of hotspots. This technique is commonly referred to as “warchalking”. Another technique, commonly referred to as “wardriving”, involves users driving around an area with a notebook computer with wireless capabilities in order to find unsecured Wi-Fi hotspots. The goal here is to find vulnerable sites either to obtain free Internet service or to potentially gain illegal access to an organization's or other user's data.

Early attempts to provide security included changing or suppressing a service set identifier (SSID) associated with a Wi-Fi access point and/or only allowing access by devices with specific addresses. These methods are easily defeated by hackers armed with packet sniffers and address spoofing equipment. In addition, precautions that hide an access point or limit computers that can access the access point are not practical in commercial applications when the access provider provides the access point to users as a service.

Other possible security precautions that may be taken by a user includes the use of a firewall at the user's device. Firewalls, however, only help protect the user's device and data thereon, but provide no protection for the data that is sent and received from the device to/from a communication network.

Virtual private networks (VPN) have also been used to provide access to a trusted, usually private network. The use of VPNs, however, also has several disadvantages, such as creating excessive traffic on the private trusted networks. In addition, VPN use often results in significant performance degradation for the user. For example, the VPN server may not be near the user's local network or the VPN server may not be designed for high-speed access, just occasional access from remote clients to the trusted network.

Other available precautions include the use of certificate authorities such as Verisign™ and Thawte™ to provide an identity service where they guarantee the identity of a device by providing the device with a digital certificate with identification information. The digital certificate is signed by one or more certificate authorities that a receiving device or user trusts. Trust exists because the digital signatures of the certificate authorities are difficult to forge, and the certificate authorities themselves have established trust throughout the user community, usually through marketing and branding. Certificate authorities, however, simply verify identity. That is, they can verify that a website or server that is accessed (e.g., my.website.com) is indeed my.website.com. Certificate authorities do not guarantee anything further about the remote service or device. The certificate authority's signature is the symbol of the guarantee. Verisign™, for example, will allow a website to place the Verisign™ logo on the site to verify that the site is secure. The logo provides assurance to users of the identity of the site and assures that all information sent to the site is sent using the secure sockets layer (SSL) security protocol.

Still other arrangements can require users to connect to and authenticate themselves with a network before they can receive any information about the network, such as the owner of the network or the security protocols supported by the network. For example, U.S. Patent Application Publication No. 2004/0030887 to Harrisville-Wolff et al., titled “System and Method for Providing Secure Communications between Clients and Service Providers”, describes an arrangement in which a network service provider first receives a request from a client that includes an identifier (e.g., a digital certificate) of the client. If the identity of the client is authenticated, access to the service provider is granted, after which a response is generated and transmitted to the client that includes an identifier or a digital certificate of the service provider. The client may then authenticate the service provider by comparing the certificate with a stored copy prior to transmitting further messages.

Arrangements, such as that described by Harrisville-Wolff et al. above can thus require that a user provide his or her personal identifying information to a network service provider prior to the user knowing the precautions, if any, the provider network employs to protect such personal information. Moreover, while these arrangements can provide a user with information identifying the owner of the network and can perhaps identify the secure transport protocols (such as SSL) that are supported by the network, these arrangements do not provide the user with a trust indication of the network or network owner themselves.

None of the above-mentioned security precautions provides assurances that access provided to a communication network, such as via a Wi-Fi hotspot or other access point, can be trusted. Accordingly, there exists a need for methods, systems, and computer program products for determining a trust indication associated with access to a communication network.

### SUMMARY

In one aspect of the subject matter disclosed herein, a method is disclosed for establishing trusted access to a communication network by a client. The method includes detecting an available access network providing access to a target communication network, determining a trust indication associated with the available access network, wherein the trust indication is originated by a trust authority, and determining whether to access the target communication network via the available access network based on the trust indication.

In another aspect of the subject matter disclosed herein, a method is disclosed for providing trusted access to a communication network at a network node. The method includes sending a trust indication message to a client prior to providing access by the client to a communication network, wherein the trust indication is associated with an available access network providing access to communication network and is originated by a trust authority, and providing access by the client to the communication network based on a response to the sent trust indication message.

In another aspect of the subject matter disclosed herein, a computer program product is disclosed. The computer program product includes computer executable instructions embodied in a computer-readable medium for performing steps including detecting an available access network providing access to a communication network, determining a trust indication associated with the available access network, wherein the trust indication is originated by a trust authority, and determining whether to access the communication network via the available access network based on the trust indication.

In another aspect of the subject matter disclosed herein, a computer program product is disclosed. The computer program product includes computer executable instructions embodied in a computer-readable medium for performing steps including sending a trust indication message to a client prior to providing access by the client to a communication network, wherein the trust indication is associated with an available access network providing access to the communication network and is originated by a trust authority, and providing access by the client to the communication network based on a response to the broadcast trust indication message.

In another aspect of the subject matter disclosed herein, a communication device for establishing trusted access to a communication network includes means for detecting an available access network providing access to a target communication network, means for determining a trust indication associated with the available access network, wherein the trust indication is originated by a trust authority, and means for determining whether to access the target communication network via the available access network based on the trust indication.

In another aspect of the subject matter disclosed herein, a communication device for establishing trusted access to a communication network includes a network interface for detecting an available access network providing access to a target communication network, a trust module for determining a trust indication associated with the available access network, wherein the trust indication is originated by a trust authority, and an access discriminator for determining whether to access the target communication network via the available access network based on the trust indication.

In another aspect of the subject matter disclosed herein, a network node for providing trusted access to a communication network includes a network interface for providing access by a client to a communication network and a trust module for sending a trust indication associated with an available access network providing access to the communication network prior to providing access by the client to the communication network, wherein the trust indication is originated by a trust authority.

In another aspect of the subject matter disclosed herein, a user interface at a client includes at least one access network identifier corresponding to an available access network providing access to a target communication network and a trust level corresponding to each access network identifier. The corresponding trust level is one of a plurality of trust levels and the corresponding trust level represents a level of trust associated with the available access network. The user interface also includes input means for initiating access by the client to the target communication network via a selected one of the at least one access network identifiers.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a schematic diagram illustrating a system for establishing trusted access to a communication network according to an aspect of the subject matter disclosed herein;

FIG. 2 is a representation of a user interface for selecting among available access networks according to an aspect of the subject matter disclosed herein;

FIG. 3 is a flow diagram illustrating a method for establishing trusted access to a communication network by a client according to an aspect of the subject matter disclosed herein;

FIG. 4 is a flow diagram illustrating a method for establishing trusted access to a communication network by a client according to another aspect of the subject matter disclosed herein;

FIG. 5 is a flow diagram illustrating a method for determining a trust indication associated with access to a communication network according to another aspect of the subject matter disclosed herein; and

FIG. 6 is a flow diagram illustrating a method for providing trusted access to a communication network at a network node according to another aspect of the subject matter disclosed herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

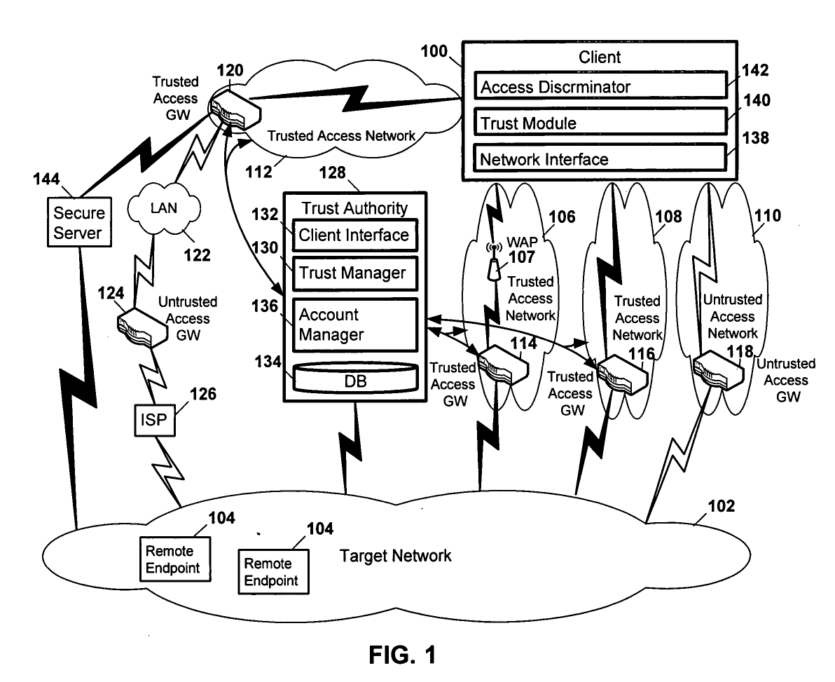

FIG. 1 is a schematic diagram illustrating a system for establishing trusted access to a communication network according to an aspect of the subject matter disclosed herein. In FIG. 1, a user of a client 100 is considering accessing a communication network 102 to communicate with one or more remote endpoints 104 accessible via network 102. For example, network 102 may be the Internet and remote endpoints 104 may be Internet sites accessible by client 100 once access is established to network 102. Alternatively, network 102 may be a metropolitan area network (MAN), wide area network (WAN), local area network (LAN), and the like, or any combination thereof. Since the user is considering accessing network 102, network 102 will be referred to herein as a “target network”. Client 100 may be any communication device, such as a computer, mobile phone, PDA, and the like.

Client 100 can access target network 102 via one of multiple available networks 106, 108, 110, and 112 providing access to target network 102. Since these networks provide access to target network 102, each will be referred to herein as an “access network”. Access networks 106, 108, 110, and 112 may include access gateways 114, 116, 118, and 120 to provide access to target network 102 either alone or in conjunction with the access networks 106, 108, 110, and 112, respectively. By way of example, access network 106 may include a Wi-Fi hotspot provided by a commercial establishment. That is, access network 106 may include a wireless access point (WAP) 107 for communicating wirelessly with client 100 when client 100 is within range of the Wi-Fi hotspot. Client 100 can communicate with target network 102 via access network 106. Access gateway 120 communicates via LAN 122 with another access gateway 124 to an Internet service provider (ISP) 126 that provides access to target network 102.

As used herein, the term “access network” refers to one or more communication nodes providing communication between a client, such as client 100, and target network 102. The access network may include, for example, an access gateway, a wireless access point, routers, switches, and other such devices. For example, the access network may include an access gateway, such as access gateways 114, 116, 118, and 120. In addition, or alternatively, the access network may include a set of communication nodes arranged to provide access to target network 102. In each case, the access network may include hard-wired, optical, or wireless components, or any combination thereof. Note that access network 112 and access gateway 120 do not provide direct access to target network 102, but instead provide indirect access, e.g., via LAN 122, access gateway 124, and ISP 126. In addition, an access network may include any of the number of protocols and software supporting communication via the access network, including security protocols. In each case, access network will be used herein to represent the above-described infrastructure and functionality.

It should also be understood that the term access network as used herein refers to a network that is, in whole or in part, under the control of an access network provider that may exercise control over the use of the access network to limit access thereto. Put another way, the access network provider may exercise some degree of control over communications via the access network to and from the target network. One example of an access network is a Wi-Fi hotspot providing controlled wireless access to the Internet (target network). The owner of the hotspot exercises control over access to the Internet by, e.g., imposing fees for the service, limiting availability of the access network, and a number of other control practices not normally associated with the Internet. Accordingly, an access network should not be considered as merely an extension of target network 102.

In FIG. 1, a trust authority 128 determines a trust indication associated with access to target network 102. Trust authority 128 is a third-party provider separate from client 100, an access network provider, and an associated access network. That is, trust authority 128 operates independently of client 100 and an access network, but may interface with both. Trust authority 128 includes means for compiling trust-related characteristics of an access network providing access to target network 102. For example, trust authority 128 includes a trust manager 130 for determining trust-related characteristics of an access network providing access to target network 102, such as access networks 106, 108, 110, and 112. In FIG. 1, trusted access networks and trusted gateways are indicated. In addition, trusted access paths are indicated in black, while untrusted access paths are indicated in white.

Trust manager 130 may determine trust-related characteristics based on one or more of several factors. For example, the use of a security protocol for providing access to the target network may be considered. Examples of security protocols include Internet protocol security protocol (IPSec), secure sockets layer (SSL), private communications technology (PCT), hypertext transport protocol secure (HTTPS), and secure hypertext transport protocol (SHTTP).

Characteristics of a device, such as an access gateway or WAP, used for providing access to the target network may also be considered by trust manager 130. For example, certain access gateways may provide higher levels of security by encrypting data and communicating the encrypted data to a secure server within the target network. Also, a WAP may provide wireless equivalent privacy (WEP) and/or Wi-Fi protected access (WPA). WEP uses an encryption key to encrypt communications. WPA is a security protocol for wireless networks from the Wi-Fi Alliance that was developed to provide a migration from WEP. WPA capable devices are compliant with a subset of the IEEE 802.11i protocol. WPA2 capable devices provide full support for the IEEE 802.11i protocol. In short, WPA and WPA2 use a sophisticated key hierarchy that generates new encryption keys each time a client establishes itself with an access point.

Trust manager 130 may also consider security applications used for providing access to a target network, such as firewall applications. Other considerations may include encryption techniques used for providing access to the target network, access control techniques used for providing access to the target network, encryption/decryption key management techniques associated with the available access network, and techniques used to ensure message integrity of messages transmitted via the available access network.

According to one aspect, trust authority 128 determines a trust indication for an access network based on trust-related characteristics determined through a contractual relationship with the access network provider. According to their relationship, the access network provider agrees to abide by certain trust-related practices for the access network in exchange for trust authority 128 providing a trust indication to users for consideration in using the access network.

According to another aspect, trust authority 128 monitors the access network to determine the trust-related characteristics. For example, an access gateway may be monitored directly, or another communication node may be placed in an access network for monitoring an access network for trust-related characteristics. Packets received at the gateway and/or traveling through the access network may be examined to determine any of the trust-related characteristics described above.

According to another aspect, trust authority 128 may perform periodic audits of the access network and/or access network provider to determine trust-related characteristics. Trust authority representatives may inspect the access network provider's site to determine security practices used and to confirm hardware and software configurations. In addition, or alternatively, trust authority 128 may receive and/or monitor feedback from users of the access network to determine trust-related characteristics of the access network.

It will be understood that any combination of the above-described techniques may be used in determining trust-related characteristics for an access network.

Trust authority 128 also includes means for determining a trust indication associated with the access network based on the compiled trust-related characteristics. For example, trust manager 130 determines a trust indication associated with the access network based on the compiled trust-related characteristics. In one implementation, a simple trusted or untrusted indicator may be used.

According to another aspect, multiple trust levels may be employed. For example, a numerical scale of trust levels 1-3 may be employed, 3 indicating the highest level of trust. Trust manager 130 considers one or more of the trust-related characteristics in determining the trust level. Three scenarios are provided below to provide additional illustration by way of example.

Scenario 1: Commercial Access, Inc.

Commercial Access is in the business of providing Wi-Fi network access to the Internet via Wi-Fi hotspots at strategic locations in a metropolitan area. Commercial Access provides an enterprise grade WAP which uses WPA2 encryption. The WAP uses a secure tunnel through Commercial Access' privately maintained business network to a secure gateway. Trust authority 128 audits Commercial Access' network and practices every three months and tracks reports of any problems reported by Commercial Access' customers. In addition, trust authority 128 has equipment monitoring Commercial Access' access networks and/or access gateways. Commercial Access receives a trust indication from trust authority 128 indicating level 3 trust.

Scenario 2: Smalltown Java

Smalltown Java wants to improve business and installs a combination router/WAP to provide customers with free access to the Internet through their Internet service provider (ISP). Smalltown Java's WAP is configured to use WEP encryption where the key is changed daily and is printed on receipts for purchases made so customers obtain the benefit of free access in exchange for their purchase. Smalltown Java has also agreed to allow annual audits of their practices by trust authority 128 and to provide customer complaints to trust authority 128. Smalltown Java receives a trust indication from trust authority 128 indicating level 1 trust.

Scenario 3: At Your Own Risk (AYOR) Networks

AYOR Networks is a consumer alliance that strongly believes Internet access should be free for all without any encumbrances. AYOR provides basic Internet access via a home router/WAP. No encryption is used, nor has trust authority 128 been contacted to establish a trust indication. Accordingly, AYOR Networks is operating an untrusted access network.

Returning to FIG. 1, trust authority 128 also includes means for making the trust indication associated with an access network available to client 100 and to multiple clients simultaneously. For example, a client interface 132 makes the trust indication available to client 100 when client 100 detects the access network. According to one aspect, client interface 132 provides the trust indication to an access gateway or WAP associated with the access network, which can then provide the trust indication to client 100 by sending a message prior to providing access by client 100 to target network 102. For example, the message may be broadcast to clients by the access gateway and/or WAP. In one implementation, the trust indication is provided to client 100 by WAP 107 when the SSID is broadcast by WAP 107.

According to another aspect, client interface 132 forwards the trust indication from trust authority 128 to client 100 via the associated access network when the client 100 detects an access network.

In another aspect, client interface 132 provides a link to the trust authority, such as a uniform resource locator (URL), to client 100. Client 100 can follow the link to locate information identifying a trust indication associated with the access network.

Client interface 132 may also provide a digital certificate signed by the trust authority. The digital certificate may include identifying information for the access network, such as the identity of the access network provider, in addition to the trust indication.

Trust authority 128 may also include a database 134 for storing information pertaining to the access networks and corresponding trust indications. Trust authority 128 may also include an account manager 136 for managing account-related issues, such as billing, and the storage of information, such as trust-related information, in database 134.

Client 100 includes means for detecting an available access network providing access to a target communication network. For example, client 100 may include a network interface 138 for detecting an available access network. Network interface 138 may detect an access gateway or WAP in the access network. For example, network interface 138 may receive an SSID broadcast from a WAP. Network interface 138 may also detect an available access network using other known communication techniques.

Client 100 also includes means for determining a trust indication associated with the available access network. For example, client 100 may include a trust module 140 for determining a trust indication associated with the access gateway. Trust module 140 can receive the trust indication from an access gateway, WAP, or any communication node, as described above. In one implementation, when a broadcast SSID message is received at network interface 138, trust module 140 extracts the trust indication from the SSID message. The trust indication may also be absent in the case of untrusted access networks, or may include an associated trust level. In each case, trust module 140 determines the appropriate trust indication. Trust module 140 may also receive the trust indication from the trust authority and/or receive a digital certificate signed by the trust authority, as described above.

Client 100 also includes means for determining whether to access target network 102 via the available access network based on the trust indication. For example, client 100 may include an access discriminator 142 for determining whether to access target network 102 via the available access network based on the trust indication. In one implementation, access discriminator 142 may allow a user to set a trust level and may only allow access to networks having at least the user-defined trust level.

Access discriminator 142 may be adapted to select between the available access network and at least one other available access network based on a comparison of respective trust indications of the available access networks. For example, access discriminator 142 may automatically select an available access network having the best trust indication, e.g. the highest trust level.

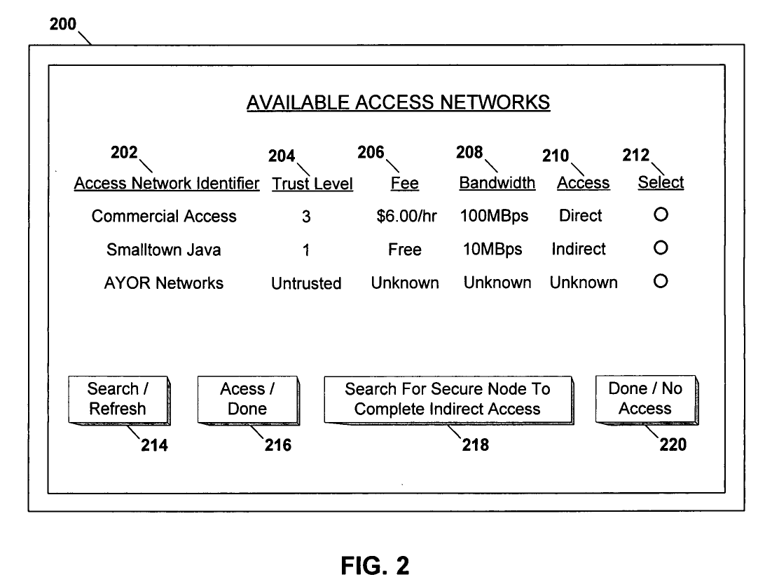

According to another aspect, access discriminator 142 may be adapted to display the determined trust indication to a user for selection via a user interface. FIG. 2 is a representation of a user interface 200 for selecting among available access networks according to an aspect of the subject matter disclosed herein. For example, user interface 200 may be a window on a computer display.

In FIG. 2, user interface 200 includes access network identifiers 202 with corresponding access network trust levels 204, access network fees 206, access network bandwidths 208, access types (direct or indirect) 210, and access network selection radio buttons 212. In addition, user interface 200 includes buttons for search/refresh 214, access/done 216, search for secure node to complete indirect access 218, and done/no access 220. User interface 200 may be presented to a user to select an available access network. Available access networks listed in user interface 200 correspond to scenarios 1-3 above. A user compares the available information and activates a corresponding radio button 212 to make a selection. Once a selection is made, access/done button 216 is activated to initiate access to target network 102 via the selected access network. Alternatively, done/no access button 220 may be activated to signify the user is not satisfied with any of the available access networks and chooses not to access target network 102. Search/Refresh button 214 may be activated to initiate or reinitiate a search for available access networks.

It will be understood that FIG. 2 illustrates one possible implementation of a user interface. As will be appreciated, not all of the information need be provided and additional information and functionality may be provided in a user interface.

Button 218 may be used to initiate a search for a secure node when an access type 210 indicates that the available access network does not provide direct access to target network 102, i.e., is more than one hop away from target network 102. When button 218 is activated, a list of available secure nodes is presented in user interface 200 for selection. Referring again to FIG. 1, a secure server 144 is shown. When client 100 establishes communication with access gateway 120, trust module 140 determines that access gateway 120 accesses target network 102 indirectly. Trust module 140 may determine a list of secure nodes accessible to access gateway 120 from trust manager of 130 in trust authority 128.

Secure server 144 may be a VPN server, for example. Access to target network 102 may be established by tunneling to secure server 144. Tunneling is a procedure involving encapsulating an entire packet of data within another packet and sending it via a network. The protocol of the encapsulating packet is understood by both the sending and receiving endpoints. Examples of protocols used for tunneling include IPSec, layer 2 tunneling protocol (L2TP), and point-to-point tunneling protocol (PPTP).

According to another aspect, access discriminator 142 is adapted to determine to automatically access target network 102 via the available access network when the trust indication corresponds to at least a minimum trust level, e.g., level 2. In addition, user interface 200 may be displayed when the determined trust indication corresponds to less than the minimum trust level to allow a user to make the determination when the trust level is not high enough to warrant automatic access.

Trusted access gateways 114, 116, and 120, and/or trusted WAP 107 include a network interface for providing access by a client to target network 102. In one aspect, the trust module sends a trust indication associated with an available access network to client 100 prior to providing access by client 100 to target network 102.

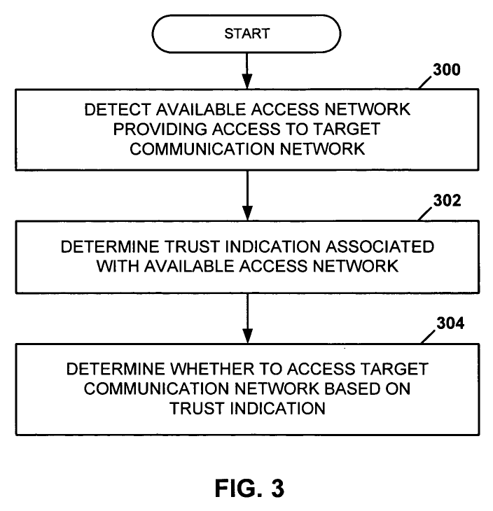

FIG. 3 is a flow diagram illustrating a method for establishing trusted access to a communication network by client 100 according to an aspect of the subject matter disclosed herein. In block 300, network interface 138 detects an available access network for providing access to target network 102. In block 302, trust module 140 determines the trust indication associated with the available access network. Access discriminator 142 determines whether to access target network 102 based on the trust indication in block 304.

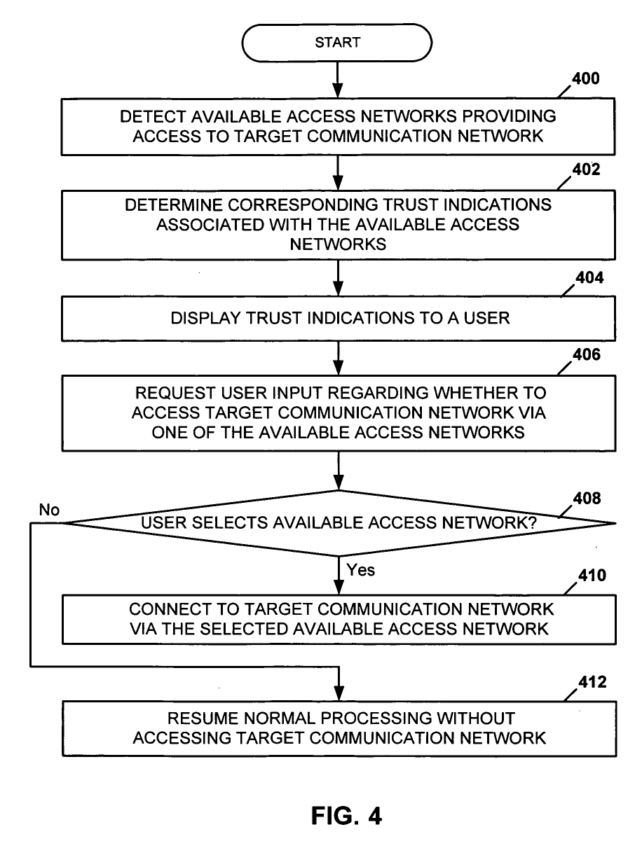

FIG. 4 is a flow diagram illustrating a method for establishing trusted access to a communication network by client 100 according to another aspect of the subject matter disclosed herein. In block 400, network interface 138 detects available access networks between client 100 and target network 102. In block 402, trust module 140 determines corresponding trust indications associated with each available access network. The corresponding trust indications are displayed to a user in block 404. For example, the corresponding trust indications may be displayed in user interface 200. In block 406, user input regarding whether to access target network 102 via one of the available access networks is requested. In response to a user selecting an available access network in block 408, client 100 accesses target network 102 via the selected available access network in block 410. If no selection is made in block 408, normal processing is resumed in block 412 pending a selection.

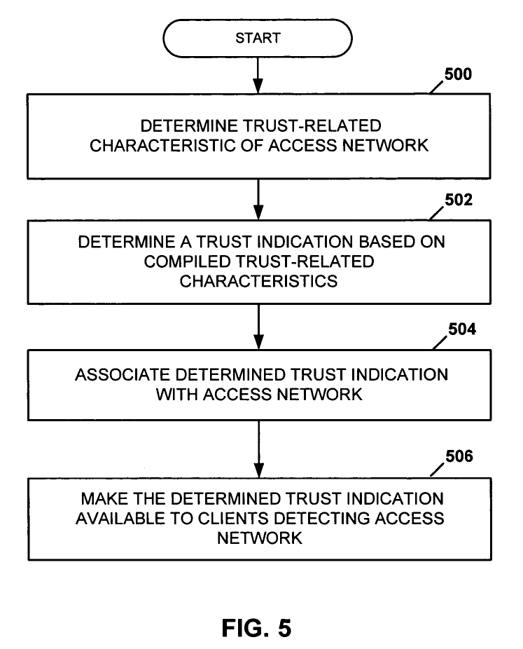

FIG. 5 is a flow diagram illustrating a method for determining a trust indication associated with access to a communication network according to another aspect of the subject matter disclosed herein. In block 500, trust manager 130 determines a trust-related characteristic of an access network. A trust indication is determined by trust manager 130 in block 502 based on the determined trust-related characteristic. In block 504, the determined trust indication is associated with the access network. For example, a record is stored in database 134 listing the access network and the corresponding trust indication. Client interface 132 makes the determined trust indication available to clients detecting the access network, as described above, in block 506.

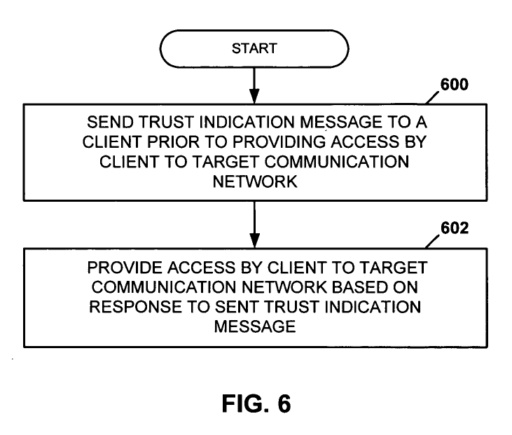

FIG. 6 is a flow diagram illustrating a method for providing trusted access to a communication network at a network node, such as an access gateway or WAP, according to another aspect of the subject matter disclosed herein. In block 600, a trust indication message is sent to client 100 prior to providing access by client 100 to target network 102. The trust indication is associated with an available access network providing access to target network 102. Access is provided between the client and the communication network based on a response to the broadcast trust indication message in block 602.

According to various aspects of the subject matter described herein, a trust indication associated with access to a communication network is determined and trusted access to the communication network is established. Accordingly, access and secure transport may be provided over the shortest path at the moment (in terms of performance) through an access network. Disadvantages in reduced performance and the added traffic on private networks resulting from the use of VPNs may be avoided. In addition, access gateways are not required to provide full VPN services. In fact, an ordinary home router/wireless access point which supports encryption over the wireless links (such as WEP or WPA) may be adequate. Thus, inexpensive networking devices can be used, rather than the more expensive VPN servers.

In addition, trust may be established for the access network through a contractual relationship between a trust authority and the access network provider. Moreover, establishing trust for an access network is a valuable service that may be billable by an access provider and/or trust authority as a premium service.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for establishing trusted access to a communication network by a client, the method comprising:
at a client:
(a) detecting an available access network providing access to a target communication network;
(b) determining a trust indication associated with the available access network, wherein the trust indication is originated by a trust authority, the trust authority being separate from the client and from the available access network; and
(c) determining whether to access the target communication network via the available access network based on the trust indication.

2. The method of claim 1 wherein detecting an available access network providing access to a target communication network includes detecting an access gateway.

3. The method of claim 1 wherein detecting an available access network providing access to a target communication network includes detecting a wireless access point.

4. The method of claim 1 wherein determining a trust indication associated with the available access network includes receiving the trust indication from an access gateway.

5. The method of claim 1 wherein determining a trust indication associated with the available access network includes receiving the trust indication from the trust authority.

6. The method of claim 1 wherein determining a trust indication associated with the available access network includes receiving a digital certificate signed by the trust authority, wherein the digital certificate includes identifying information for the available access network.

7. The method of claim 1 wherein determining a trust indication associated with the available access network includes determining one of a plurality of trust levels based on the trust indication.

8. The method of claim 1 wherein the trust indication associated with the available access network is based on at least one of a security protocol used to provide access to the target communication network, characteristics of a device used to provide access to the target communication network, security applications used to provide access to the target communication network, encryption techniques used to provide access to the target communication network, access control techniques used to provide access to the target communication network, encryption/decryption key management techniques associated with the available access network, techniques used to ensure message integrity of messages transmitted via the available access network, a contractual relationship between a provider of the available access network and the trust-authority, audits of the provider of the available access network, and monitoring of problems reported by users of the available access network.

9. The method of claim 1 wherein determining whetherto access the target communication network via the available access network based on the trust indication comprises selecting between the available access network and at least one other available access network providing access to the target communication network, the selection being based on a comparison of respective trust indications of the available access networks.

10. The method of claim 1 wherein determining whether to access the target communication network via the available access network based on the trust indication comprises:
(a) displaying the determined trust indication to a user;
(b) requesting user input regarding whether to access the target communication network via the available access network; and
(c) determining whether to access the-target communication network via the available access network responsive to receiving the requested user input.

11. The method of claim 1 wherein determining whetherto access the target communication network via the available access network based on the trust indication includes determining to access the target communication network when the determined trust indication corresponds to at least a minimum trust level.

12. The method of claim 11 wherein determining whether to access the target communication network via the available access network based on the trust indication comprises:
(a) in response to the determined trust indication corresponding to less than the minimum trust level:
(i) displaying the trust indication to a user;
(ii) requesting user input regarding whether to access the target communication network via the available access network; and
(iii) determining whether to access the target communication network via the available access network responsive to receiving the requested user input.

13. The method of claim 1 comprising, in response to determining to access the target communication network via the available access network, establishing secure access via a secure node providing secure communications with the target communication network.

14. The method of claim 13 wherein establishing secure access via a secure node providing secure communications with the target communication network includes tunneling to a secure server.

15. A method for providing trusted access to a communication network, the method comprising:
at a network node:
(a) sending a trust indication message to a client prior to providing access by the client to a target communication network, wherein the trust indication is associated with an available access network providing access to the target communication network and is originated by a trust authority, the trust authority being separate from the client and from the available access network; and
(b) providing access to the target communication network based on a response to the sent trust indication message.

16. A computer program product comprising computer executable instructions embodied in a computer-readable medium for performing steps comprising:
at a client:
(a) detecting an available access network providing access to a target communication network;
(b) determining a trust indication associated with the available access network, wherein the trust indication is originated by a trust authority, the trust authority being separate from the client and from the available access network; and
(c) determining whether to access the target communication network via the available access network based on the trust indication.

17. A computer program product comprising computer executable instructions embodied in a computer-readable medium for performing steps comprising:
at a network node:
(a) sending a trust indication message to a client prior to providing access by the client to a target communication network, wherein the trust indication is associated with an available access network providing access to the target communication network and is originated by a trust authority, the trust authority being separate from the client and from the available access network; and
(b) providing access to the target communication network based on a response to the sent trust indication message.

18. A communication device for establishing trusted access to a communication network comprising:
(a) means for detecting an available access network providing access to a target communication network;
(b) means for determining a trust indication associated with the available access network, wherein the trust indication is originated by a trust authority, the trust authority being separate from the client and from the available access network; and
(c) means for determining whether to access the target communication network via the available access network based on the trust indication.

19. A communication device for establishing trusted access to a communication network comprising:
(a) a network interface for detecting an available access network providing access to a target communication network;
(b) a trust module for determining a trust indication associated with the available access network, wherein the trust indication is originated by a trust authority, the trust authority being separate from the client and from the available access network; and
(c) an access discriminator for determining whether to access the target communication network via the available access network based on the trust indication.

20. The communication device of claim 19 wherein the network interface is adapted to detect an access gateway.

21. The communication device of claim 19 wherein the network interface is adapted to detect a wireless access point.

22. The communication device of claim 19 wherein the trust module is adapted to receive the trust indication from an access gateway.

23. The communication device of claim 19 wherein the trust module is adapted to receive the trust indication from the trust authority.

24. The communication device of claim 19 wherein the trust module is adapted to receive a digital certificate signed by the trust authority, wherein the digital certificate includes identifying information for the available access network.

25. The communication device of claim 19 wherein the trust module is adapted to determine one of a plurality of trust levels based on the trust indication.

26. The communication device of claim 19 wherein the trust indication associated with the available access network is based on at least one of a security protocol used to provide access to the target communication network, characteristics of a device used to provide access to the target communication network, security applications used to provide access to the target communication network, encryption techniques used to provide access to the target communication network, access control techniques used to provide access to the target communication network, encryption/decryption key management techniques associated with the available access network, techniques used to ensure message integrity of messages transmitted via the available access network, a contractual relationship between a provider of the available access network and the trust authority, audits of the provider of the available access network, and monitoring of problems reported by users of the available access network.

27. The communication device of claim 19 wherein the access discriminator is adapted to select between the available access network and at least one other available access network providing access to the target communication network, the selection being based on a comparison of respective trust indications of the available access networks.

28. The communication device of claim 19 wherein the access discriminator is adapted to:
(a) display the determined trust indication to a user;
(b) request user input regarding whether to access the target communication network via the available access network; and
(c) determine whether to access the target communication network via the available access network responsive to receiving the requested user input.

29. The communication device of claim 19 wherein the access discriminator is adapted to determine to access the target communication network via the available access network when the determined trust indication corresponds to at least a minimum trust level.

30. The communication device of claim 29 wherein the access discriminator is adapted to, in response to the determined trust indication corresponding to less than the minimum trust level:
(a) display the trust indication to a user;
(b) request user input regarding whether to access the target communication network via the available access network; and
(c) determine whether to access the target communication network via the available access network responsive to receiving the requested user input.

31. The communication device of claim 19 wherein the access discriminator is adapted to, in response to determining to access the target communication network via the available access network, establish secure access via a secure node providing secure communications with the target communication network.

32. The communication device of claim 31 wherein the access discriminator is adapted to establish secure access with the target communication network by tunneling to a secure server.

33. A network node for providing trusted access to a communication network, the network node comprising:
(a) a network interface for providing access by a client to a target communication network; and
(b) a trust module for sending a trust indication associated with an available access network providing access by the client to the target communication network, wherein the trust indication is originated by a trust authority, the trust authority being separate from the client and from the available access network.

34. The network node of claim 33 wherein the network node is an access gateway.

35. The network node of claim 33 wherein the network node is a WAP.

36. A user interface at a client, the user interface comprising:
(a) at least one access network identifier corresponding to an available access network providing access to a target communication network;
(b) a trust level corresponding to each access network identifier, wherein the corresponding trust level is one of a plurality of trust levels and the corresponding trust level represents a level of trust associated with the available access network; and
(c) input means for initiating access by the client to the target communication network via a selected one of the at least one access network identifiers.

37. The user interface of claim 36 wherein the trust level is originated by a trust authority, the trust authority being separate from the client and from the available access network.
